(19) United States
(12) Patent Application Publication
(10) Pub. No.: US 2026/0326729 A1
(43) Pub. Date: Oct. 22, 2026

(54) CONTROL DEVICE FOR A BRAKE SYSTEM, SYSTEM FOR CONTROLLING A BRAKE SYSTEM AND METHOD FOR CONTROLLING A BRAKE SYSTEM

(71) Applicant: Robert Bosch GmbH, Stuttgart (DE)

(72) Inventors: Martin Marquart, Ludwigsburg (DE); Florian Haag, Ellhofen (DE); Nikolas Loeffelmann, Dielheim (DE)

(21) Appl. No.: 19/104,781

(22) PCT Filed: Oct. 12, 2023
(86) PCT No.: PCT/EP2023/078385

§ 371 Date: Feb. 19, 2025

(30) Foreign Application Priority Data
Oct. 20, 2022 (DE) 10 2022 211 137.0

(51) Int. Cl. B60T 8/172; B60T 8/171

(52) U.S. Cl. CPC B60T 8/172; B60T 8/171; B60T 2220/04; B60T 2270/406; B60T 2270/413

(57) ABSTRACT

Control of a brake system, in particular a brake-by-wire system. In addition to a purely local calculation of the parameters for converting a braking request into an actuating command for a brake actuator, a calculation of parameters by a remote processing apparatus, for example in a cloud or similar, is provided. This makes it possible to relieve the load on the locally required hardware.

### FIELD

The present invention relates to a control device for a brake system, to a system for controlling a brake system and to a method for controlling a brake system. In particular, the present invention relates to controlling a system in a motor vehicle.

### BACKGROUND INFORMATION

Brake systems for vehicles, in particular for motor vehicles such as cars or trucks, can be implemented as electrohydraulic brake systems. Typically, such brake systems have a master brake cylinder comprising an actuator piston. This can be actuated either directly manually or by means of a brake booster. The hydraulic pressure generated in the master brake cylinder is transmitted to the wheel brakes to build up brake pressure.

Increasingly, so-called brake-by-wire systems are also being used. Such a system is described, for example, in German Patent Application No. DE 10 2011 079 454 A1. In this brake system, hydraulic pressure is generated in a simulator device by actuating a master brake cylinder. The pressure generated by the master brake cylinder is detected and, based on the detected pressure, a target brake pressure is ascertained, which is set in an active circuit for actuating the wheel brakes by means of a pressure generating device, which has an electric motor and a displacement piston that can be moved by means of the electric motor.

### SUMMARY

The present invention provides a control device for a brake system, a system for controlling a brake system and a method for controlling a brake system. Advantageous embodiments of the present invention are disclosed herein.

According to an example embodiment of the present invention, the following is provided:

A control device for a brake system comprising a processing device and a radio interface. The processing device is designed to receive data from a target value generator. Furthermore, the processing device is designed to ascertain an actuating command for a brake actuator. In particular, the actuating command can be ascertained using the data received from the target value generator and control data. Furthermore, the processing device is designed to output the ascertained actuating command for the brake actuator. The radio interface is designed to receive control data, in particular the control data for ascertaining the actuating command, from a remote processing apparatus.

Furthermore, according to an example embodiment of the present invention, the following is provided:

A system for controlling a brake system in a motor vehicle comprising a control device according to the present invention and a processing apparatus remote from the motor vehicle. Here, the control device is arranged in the motor vehicle. The processing apparatus is designed to receive data from the radio interface of the control device in the motor vehicle. Furthermore, the processing apparatus is designed to generate, i.e. calculate, control data using the received data. Furthermore, the processing apparatus is designed to send the generated control data to the radio interface of the control device in the motor vehicle.

And, according to an example embodiment of the present invention, the following is provided:

A method for controlling a brake system in a motor vehicle. The method comprises a step for receiving control data for a braking operation. In particular, the control data can be received from a remote processing apparatus via a wireless communication link. Furthermore, the method comprises a step for receiving data from a local target value generator. The local target value generator can, for example, be a sensor for detecting the current position of a brake pedal. Furthermore, the method comprises a step for ascertaining an actuating command for a brake actuator. Ascertaining the actuating command for the brake actuator can be carried out in particular using the data received from the target value generator and the control data from the remote processing apparatus. Finally, the method can comprise a step for outputting the ascertained actuating command to the brake actuator.

In modern brake systems, in particular brake-by-wire systems, a braking request for the motor vehicle can be provided by a target value generator as a digital or, if applicable, analog signal and transmitted to a control unit via a communication link. For example, a sensor can detect the current position of a brake pedal and provide a signal corresponding to the position of the brake pedal, which is transmitted to the control unit via the communication link. In addition or alternatively, a braking request can also be generated by a component of a system for fully or at least partially autonomous driving and transmitted to the control unit of the brake system.

According to an example embodiment of the present invention, the control unit of the brake system then processes the received request for a braking request, which has been received, for example, in the form of the current position of the brake pedal or in any other form. The control unit of the brake system ascertains a control command for an actuator of the brake system and outputs this control command to the corresponding actuator. As a result, the actuator of the brake system can be controlled such that it can build up a brake pressure in the brake system that corresponds to the received request.

The present invention is based on the realization that the processing of the requests for a braking request up to the output of the corresponding actuating command for the brake actuator is of great importance. Therefore, a very high level of fail-safety and redundancy must be ensured here. However, this is associated with significant effort and costs.

It is therefore a feature of the present invention to take this realization into account and to provide a control device for a brake system, in particular a brake-by-wire brake system, which can ensure a high degree of operational safety with as little local effort as possible. According to the present invention, in addition to purely local processing of the received target values for a braking request for generating the actuating commands for a brake actuator, a processing path is also provided, with which the data processing can be carried out at least partially by a remote processing apparatus.

The remote processing apparatus can be a remote server, for example a server or a server structure in a cloud. The data exchange between the local control device for the brake system and the remote processing apparatus can be carried out here via a wireless communication link. For example, the data exchange can be carried out via a mobile phone connection or similar. In principle, however, any other wireless communication links, in particular radio connections with the lowest possible latency, are also possible.

This means that by using remote resources to process a braking request, the amount of hardware required locally in the motor vehicle can be minimized. If, for example, the remote infrastructure is primarily used to process the braking request, it is sufficient to provide a fallback level in the motor vehicle for processing the braking request. As a result, sufficient safety for processing the braking request can be ensured even upon a failure or fault of the communication link to the remote processing apparatus.

According to an example embodiment of the present invention, the at least partial data processing by a remote processing apparatus for controlling a brake system in a motor vehicle can also open up further advantages in addition to simplifying the required local system in the motor vehicle. For example, it is possible to provide a more powerful hardware infrastructure for data processing in the remote processing apparatus, which can also perform complex calculations very efficiently. As a result, if applicable, the accuracy and/or processing speed of the processing of corresponding data can be increased. Furthermore, if applicable, the remote processing apparatus can also access additional resources such as databases. For example, user-specific data can be provided in the remote processing apparatus. This means, for example, that the braking behavior of vehicles can be adapted in accordance with such user-specific specifications. This makes it possible, for example, to provide a user with at least approximately the same or similar braking behavior of the vehicle being used in each case, even when switching vehicles. For example, subsequent adaptations, such as manufacturer-specific specifications, can also be easily provided at a central remote processing apparatus, without having to call all vehicles back to a workshop for a software update.

According to one example embodiment of the present invention, the radio interface is designed to transmit operating data of the brake system to the remote processing apparatus. This operating data can, for example, be technical data of the brake system or components of the brake system. For example, information such as the current temperature of brake system components, detected error messages or similar can be transmitted to the remote processing apparatus. In addition, information from the particular brake system stored locally in the vehicle, for example, such as calibration data or similar, can also be transmitted to the remote processing apparatus. As a result, the remote processing apparatus is able to adapt the processing as precisely as possible to the particular brake system.

According to one example embodiment of the present invention, the radio interface is designed to transmit user-specific data to the remote processing apparatus. The user-specific data can, for example, be an identifier of the particular user/driver. As a result, the remote processing apparatus can easily identify the particular user and adapt the data processing to the particular user. For example, previously specified and stored user profiles can be read from a database of the remote processing apparatus and taken into account upon data processing. As a result, an individually adapted braking behavior of the vehicle for each user is made possible. In this way, profiles that are individually adapted in each case for the braking characteristics can be implemented for different users on one and the same vehicle. Furthermore, it is also possible, in this way, to provide a user with the same or at least approximately the same braking characteristics on the vehicle they are using in each case when switching vehicles. As a result, the particular user does not have to adjust to significantly different braking characteristics when switching vehicles.

In addition to transmitting a user ID for identifying the user in the remote processing apparatus, it is also possible for a user in the vehicle to specify their preferences. In this case, the user specifications can be transmitted to the remote processing apparatus via the radio interface, so that the remote processing apparatus can take these user-specific specifications into account.

According to one example embodiment of the present invention, the processing device is designed to ascertain first data for an actuating command for the brake actuator using the control data received from the radio interface. Furthermore, the processing device can be designed to ascertain second data for an actuating command for the brake actuator using local control data. In addition, the processing device can be designed to output the first data for the actuating command of the brake actuator if a deviation between the first data and the second data for the actuating command falls below a predetermined threshold value. Alternatively, in the event that the deviation between the first data and the second data exceeds the predetermined threshold value, the actuating command can be generated and output on the basis of the locally ascertained second data. In this way, the control data from the remote processing device can be checked for plausibility. If too great a discrepancy is determined between the locally ascertained data and the data from the remote processing apparatus, the data received from the remote processing apparatus are discarded and the control is carried out based on the locally ascertained data. If, on the other hand, the data from the remote processing apparatus can be confirmed as plausible, the generally more precise data from the remote processing device can be used.

According to one example embodiment of the present invention, the processing device is designed to monitor a communication link between the radio interface and the remote processing apparatus. In this case, the processing device can further be designed to output the second data for the brake actuator command if a fault has been detected in the communication link between the radio interface and the remote processing apparatus. Here, the communication link can be checked using any suitable measures. For example, a time span between sending data from the local radio interface to the remote processing apparatus and receiving a response from the remote processing apparatus can be ascertained. If this time span exceeds a predefined limit value, this may be an indication of a possible fault in the communication link. In addition, any other measures can be used to check the communication link. In the event of a detected fault in the communication link, the locally ascertained data can be used.

According to one example embodiment of the present invention, the processing device is designed to ascertain a signal propagation time between the radio interface and the remote processing apparatus and to ascertain the control command for the brake actuator using the ascertained signal propagation time. By monitoring the signal propagation time, on the one hand, a possible fault in the communication link can be identified. In addition, possible delays due to the ascertained signal propagation time can also be taken into account and the control of the brake actuator can be adapted accordingly.

According to one example embodiment of the present invention, the processing device is designed to monitor a local ascertainment of the actuating command of the brake actuator. Furthermore, the processing device can be designed to ascertain the control data for the actuating command of the brake actuator using control data from the radio interface, if a malfunction has been detected upon the local ascertainment. Here, the local hardware is primarily used to ascertain the actuating commands for the brake actuator. However, if an error is detected in the local hardware, for example due to a software error or a memory access error, the processing in the remote processing device can be used as redundancy.

The above embodiments and developments can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the respective basic forms of the present invention.

### BRIEF DESCRIPTION OF THE DRAINGS

Further features and advantages of the present invention will be explained in the following with reference to the figures.

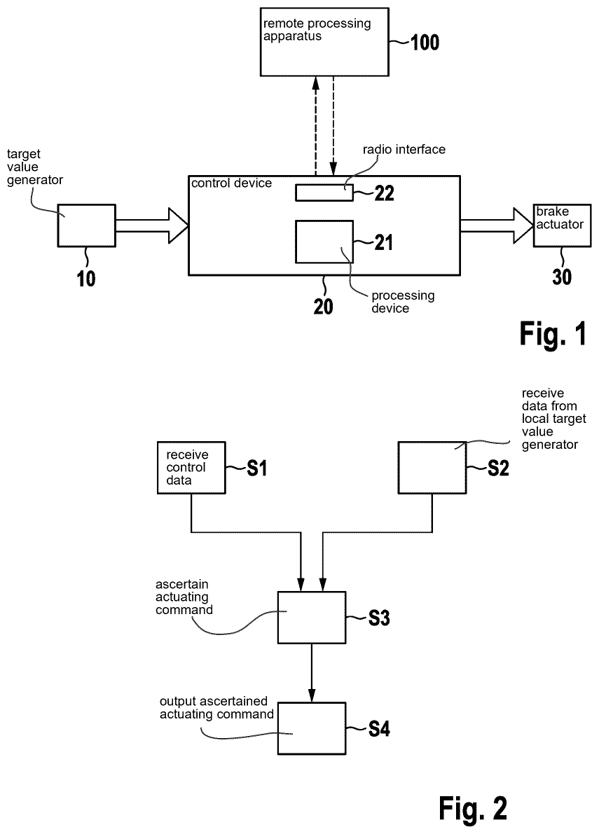

FIG. 1 is a schematic representation of a block diagram of a system for controlling a brake system according to one example embodiment of the present invention.

FIG. 2 shows a flow chart of a method for controlling a brake system according to one example embodiment of the present invention.

### DETAILED DESCRIPTION OF EXAMPLE EMBODIMENTS

FIG. 1 is a schematic representation of a block diagram of a system for controlling a brake system according to one embodiment. The brake system comprises, among other things, a target value generator 10, which provides a target value corresponding to a braking request. The target value generator 10 can, for example, be a sensor that provides a digital or, if applicable, analog sensor value corresponding to the position of a brake pedal in a motor vehicle. This sensor value can be transmitted to a control device 20 via a communication link, for example a data bus or similar. In addition or as an alternative to the data on the position of the brake pedal in the motor vehicle, it is also possible for a system for fully or at least partially autonomous driving to generate a braking request and provide this braking request to the control device 20. Here as well, the transmission of the braking request can be carried out via a suitable communication link, such as a data bus or similar.

The control device 20 calculates an actuating command for a brake actuator from the received braking request and outputs this actuating command to the brake actuator 30. The brake actuator 30 can, for example, build up a corresponding brake pressure in the brake system in accordance with the actuating command, so that the vehicle can be decelerated with this brake system according to the braking request. For example, a simulation of the braking operation can be carried out to ascertain the actuating command. Due to such a simulation, for example, control data can be generated, which can be used to ascertain the command for the brake actuator 30.

To calculate the actuating command for the brake actuator 30, the control device 20 can, for example, make use of local hardware, which is implemented, for example, in a processing device 21 of the control device 20. Since the conversion of the braking request into a suitable control command for the brake actuator 30 is of great importance, sufficient fail-safety and redundancy must be ensured.

In addition to the purely local calculation of the control commands for the brake actuator 30, an at least partially offloaded calculation to a remote processing apparatus 100 is therefore also possible. For this purpose, a radio interface 22 is provided in the local control device 20 of the brake system. Via this radio interface 22, the control device 20 can send data to the remote processing apparatus 100 and receive data from the remote processing apparatus 100. For example, the radio interface 22 can use a communication link based on a suitable mobile radio standard for this purpose. In principle, however, any other standardized or proprietary wireless communication links are also possible.

For example, the control device 20 can transmit data to the remote processing apparatus 100 by means of the radio interface 22. The remote processing apparatus 100 can then perform a calculation of control data for the brake system based on the transmitted data from the control device 20 and transmit the calculated control data to the control device 20. The radio interface 22 of the control device 20 can receive these data and provide them, for example, to the processing device 21 in the control device 20. The processing device 21 can then use these control data from the remote processing apparatus 100 to ascertain an actuating command for the brake actuator 30 and provide it to the brake actuator. In this way, at least part of the data processing can be offloaded from the local control device 20 to the remote processing apparatus 100. As a result, the required hardware for the control device 20 can be implemented accordingly more easily and cost-effectively. If, for example, the calculation of the control data is primarily offloaded to the external processing apparatus 100, it is sufficient to provide only a simple redundant processing option in the local control device 20, in particular the processing device 21. As a result, it is possible to ensure the reliable ascertainment of control data even in the event of a failure of the remote processing apparatus 100 or the communication link between the radio interface 22 and the remote processing apparatus 100.

For example, control data can be generated by the remote processing apparatus 100, which in each case correspond to the current conditions for correlations or characteristic curves between the received target values and the control of the brake actuator 30. In each case, these control data can be dynamically adapted in accordance with the current conditions. This dynamic adaptation can, for example, be carried out in the remote processing apparatus 100.

For example, the control data can be adapted according to current operating parameters such as the temperature in the brake system, detected faults or error messages or similar. For this purpose, the processing device 20 can, for example, have suitable interfaces that receive the respective operating parameters and then forward them to the remote processing apparatus 100.

It is also possible, for example, to individually adapt the control data for a user. For example, a user can specify their preferences, such as a rather hard direct or preferably soft response of the brakes. For example, a user interface (not shown) can be provided for this purpose, by means of which a user can specify their preferences. These user inputs can likewise be transmitted to the remote processing apparatus 100 via the radio interface 22.

In addition or alternatively, a user ID can also be transmitted to the remote processing apparatus 100. Accordingly, the individual specifications of a user can be assigned to the particular user according to this user ID. For example, it is possible that the respective user-specific parameters are stored in a database or similar in the remote processing apparatus 100. In this way, the remote processing apparatus 100 can automatically ascertain the user-specific parameters after obtaining the particular user ID, for example by reading them from a database, and adapt the control parameters in accordance with these user-specific parameters. For example, the user can be identified by means of a corresponding user input or an identification medium, such as an RFID chip, a smartphone or similar.

If the particular user is known to the remote processing apparatus 100, it is also possible to adapt the control data for the particular brake system such that a user also receives in each case at least approximately the same or similar braking behavior in different vehicles. In this way, in each case the user can experience a familiar braking behavior even when using different vehicles.

By calculating the control data in the remote processing apparatus 100, it may be sufficient to adapt the ascertainment of the control data in a suitable manner for adapting the brake system. In such a case, it is sufficient for the corresponding adaptations to be carried out in the central local processing apparatus 100. As a result, if applicable, a costly update of the software in the individual vehicles by means of a recall to a workshop or similar can be avoided or at least delayed.

To check the plausibility of the control data from the remote processing apparatus 100, for example, an actuating command as transmitted by the control data from the remote processing apparatus 100 can be compared with an actuating command that has been ascertained by a local calculation in the control device 20. If the values of the actuating commands of the local calculation and the remote calculation do not deviate significantly from one another, i.e. less than a predefined threshold value, the corresponding actuating commands can be classified as plausible. In such a case, for example, the actuating command can preferably be used based on the control data from the remote processing apparatus 100. If, on the other hand, a significant deviation is detected in the two actuating commands, an error in the calculation of the control data from the remote processing apparatus 100 or in the communication link between the local control device 20 and the remote processing apparatus 100 can be inferred in such a case. In such a case, the data based on the locally ascertained control data can preferably be used for the control command of the brake actuator 30.

Furthermore, it is also possible, for example, to monitor the communication link between the radio interface 22 and the remote processing apparatus 100. For example, a time span between sending data from the local radio interface 22 to the remote processing apparatus 100 and subsequently receiving data from the remote processing apparatus 100 by the radio interface 22 can be analyzed for this purpose. If this time span exceeds a predefined limit value, this can be interpreted as an indication of a fault in the communication link. Accordingly, upon the detection of a fault, the locally ascertained control data and the resulting control command for the brake actuator 30 can preferably be used.

In an alternative embodiment, it is also possible to initially rely primarily on the local ascertainment of the control data and to use the actuating commands based thereon for the brake actuator 30, and to use the calculation of the control data in the remote processing apparatus 100 only upon the detection of a fault or similar. For example, the processing in the local processing device 21 can be monitored by a higher-level instance. If a software error, a memory access error or another critical error is detected, the calculation of the control data by the remote processing apparatus 100 can be used in such a case.

FIG. 2 shows a flow chart of a method for controlling a brake system in a motor vehicle according to one embodiment. The method can in principle comprise any steps as described above in connection with the brake system according to FIG. 1.

Accordingly, the above-described brake system can also comprise any components required to implement the method described below.

The method comprises a step S1 of receiving control data for a braking operation from a remote processing apparatus 100 via a wireless communication link. The remote processing apparatus 100 can ascertain the control data for a braking operation, in particular in the manner described above.

Furthermore, the method comprises a step S2 for receiving data from a local target value generator 10. The local target value generator 10 can, for example, be a sensor that ascertains the position of a brake pedal in a vehicle. In addition or alternatively, target values for a braking operation can also be received from a control system for fully or at least partially autonomous driving.

In a step S3, an actuating command for a brake actuator 30 is ascertained. The ascertainment of the actuating command is carried out in particular using the data received from the target value generator 10 and the control data from the remote processing apparatus 100.

Finally, in step S4, the ascertained actuating command is output to the brake actuator 30.

Further, the method can comprise a step for wirelessly transmitting user-specific data, operating data of the brake system and/or environmental data to the remote processing apparatus. As a result, as mentioned above, the control data can, for example, be individually adapted to the specifications of individual users. In addition, the control data can also be dynamically adapted in each case to the current operating data of the brake system, for example. Furthermore, for example, the control data can also be adapted according to environmental parameters such as the detected wetness, risk of slipping on the road or any other environmental parameters.

In summary, the present invention relates to controlling a brake system, in particular a brake-by-wire system. For this purpose, in addition to a purely local calculation of the parameters for converting a braking request into an actuating command for a brake actuator, a calculation of parameters by a remote processing apparatus, for example in a cloud or similar, is provided. This makes it possible to relieve the load on the locally required hardware.

1-10. (canceled)

11. A control device for a brake system, comprising:
a processing device configured to receive data from a target value generator, ascertain an actuating command for a brake actuator using the received data from the target value generator and control data, and output the ascertained actuating command for the brake actuator; and
a radio interface configured to receive the control data from a remote processing apparatus.

12. The control device according to claim 11, wherein the radio interface is further configured to transmit operating data of the brake system to the remote processing apparatus.

13. The control device according to claim 11, wherein the radio interface is further configured to transmit user-specific data to the remote processing apparatus.

14. The control device according to claim 11, wherein:
the processing device is configured to ascertain first data for an actuating command for the brake actuator using the control data received from the radio interface and to ascertain second data for an actuating command for the brake actuator using local control data; and
the control device is configured to output the first data for the actuating command of the brake actuator, when a deviation between the first data and the second data for the actuating command falls below a predetermined threshold value.

15. The control device according to claim 14, wherein the processing device is configured to monitor a communication link between the radio interface and the remote processing apparatus, and to output the second data for the actuating command of the brake actuator, when a fault has been detected in the communication link between the radio interface and the remote processing apparatus.

16. The control device according to claim 1, wherein the processing device is configured to ascertain a signal propagation time between the radio interface and the remote processing apparatus, and to ascertain the control command for the brake actuator using the ascertained signal propagation time.

17. The control device according to claim 1, wherein the processing device is configured to monitor a local ascertainment of the actuating command of the brake actuator, and to ascertain the control data for the actuating command of the brake actuator using control data from the radio interface, when a malfunction has been detected of the local ascertainment.

18. A system for controlling a brake system in a motor vehicle, comprising:
a control device arranged in the motor vehicle, the control device including:
a processing device configured to receive data from a target value generator, ascertain an actuating command for a brake actuator using the received data from the target value generator and control data, and output the ascertained actuating command for the brake actuator, and
a radio interface configured to receive the control data from a remote processing apparatus; and
the remote processing apparatus which is remote from the motor vehicle, the remote processing apparatus being configured to receive data from the radio interface of the control device in the motor vehicle, to generate the control data using the received data, and send the generated control data to the radio interface of the control device in the motor vehicle.

19. A method for controlling a brake system in a motor vehicle, comprising the following steps:
receiving control data for a braking operation from a remote processing apparatus via a wireless communication link;
receiving data from a local target value generator;
ascertaining an actuating command for a brake actuator using the received data from the target value generator and the control data from the remote processing apparatus; and
outputting the ascertained actuating command to the brake actuator.

20. The method according to claim 19, further comprising wirelessly transmitting to the remote processing apparatus user-specific data, and/or operating data of the brake system and/or environmental data.
